(19) United States
(12) Patent Application Publication
(10) Pub. No.: US 2014/0051041 A1
(43) Pub. Date: Feb. 20, 2014

(54) DRIVER BEHAVIOR MONITOR AND ANALYZER

(71) Applicant: Ford Global Technologies, LLC, Dearborn, MI (US)

(72) Inventors: Frederic Stefan, Aachen (DE); Uwe Gussen, Huertgenwald (DE); Goetz-Philipp Wegner, Dortmund (DE); Thomas Rambow, Aachen (DE)

(21) Appl. No.: 13/944,031

(22) Filed: Jul. 17, 2013

(30) Foreign Application Priority Data
Aug. 14, 2012 (DE) 102012214464.1

(51) Int. Cl. G09B 19/16

(52) U.S. Cl. CPC G09B 19/167
USPC 434/65

(57) ABSTRACT

A system for monitoring and analyzing the driving behavior of a driver in a motor vehicle includes a traffic-rule-conformance evaluation module (3) which evaluates the driving behavior of the driver with regard to adherence to elementary traffic rules. A defensive-driving-style evaluation module (4) evaluates the driving style of the driver under general safety aspects which are not or not always unambiguously specified by legal regulations. A rating-number specification module (5) specifies and updates continuously a rating number which represents a measure of the conformance to rules of driving behavior and defensiveness of the driving style of the driver. A communication module (6) communicates with the rating-number specification module (5) and establishes a data link with a remote data processing device (8). After the rating number has reached or exceeded a predetermined threshold value, this fact is reported to the remote data processing device (8) via the communication module (6).

### CROSS REFERENCE TO RELATED APPLICATIONS

This application claims priority to application 102012214464.1, filed in the German Patent and Trademark Office on Aug. 14, 2012, which is hereby incorporated by reference.

### STATEMENT REGARDING FEDERALLY SPONSORED RESEARCH

Not Applicable.

### BACKGROUND OF THE INVENTION

The present invention relates in general to a system for monitoring and analyzing the driving behavior of a driver in a motor vehicle, and, more specifically, to a reward-based system for enabling a driver to improve the driver's standing in a licensing points system by exhibiting compliant driving behavior.

In many countries, car drivers, at least those who have become noticed due to violations of traffic rules, have a so-called points rating in a traffic offenders file kept by a responsible authority. If a driver violates a traffic rule sanctioned with points, his points rating is loaded with the corresponding number of points, either by addition to or by subtraction from a starting value depending on the country. If a particular licensed driver has collected or lost too many points, he can lose his driving license or have restrictions placed upon it. Drivers are often given the opportunity to improve or restore their score again, e.g. by persevering for a relatively long time without further violations of traffic rules or by participating in special training sessions. However, training sessions require a great deal of expenditure for all parties involved and do not guarantee that a driver will maintain a safer driving style in future.

EP 1717777B1 discloses a system to support a driver in adhering to traffic rules by monitoring his driving behavior by means of sensors and comparing it with the environmental situation and the applicable traffic restrictions. If the system detects a violation, it warns the driver, for example by indicating the fine and/or the number of points the driver is currently risking. The system can also intervene in the vehicle control, e.g. by braking.

US 2010/0063850A1 discloses a system which collects data in a motor vehicle which may be relevant to the insurance risk of the driver. The data is conveyed wirelessly to an evaluation center of an insurance company. The collected data includes data from various sensors in the motor vehicle, information about safety belts, the presence of airbags, and the operating state of the windscreen wipers. Thus, some data extend beyond the current driving behavior of the driver. Apart from the evaluation center, the driver can also communicate with the system and have data displayed.

The above and other known systems have in common that their primary aim is to induce the driver to a safe driving behavior by disclosing to him the consequences of unsafe driving, e.g. by situation-dependent advisories of legal sanctions or by the knowledge that the insurance company is monitoring him or her.

### SUMMARY OF THE INVENTION

The present invention is based on the object of providing a system for monitoring and analyzing the driving behavior of a driver which does not admonish him to adopt a safe driving style by means of monitoring, warning or even punishment but stimulates him to a safe driving style by rewarding him or her.

The invention enables drivers who are penalized with points (or loss of points) stored in a traffic offenders file by a licensing authority to improve their score by means of their driving behavior, namely by voluntary adherence to traffic rules and voluntary defensive driving. A reward for safe, compliant driving creates a strong stimulus for drivers to use the system. In this context, particularly good behavior in road traffic can be rewarded by particularly rapid adjustment of points.

Drivers who have used the system according to the invention easily become used to a rule-compliant, defensive driving style which they also tend to retain when they are no longer burdened with points because the reward-based invention creates a much more effective training effect than a penalty-based monitoring system. The reason for this is that drivers who have used the system according to the invention voluntarily feel challenged to effect an improvement of their score on their own responsibility which has a particularly effective lasting learning effect. This will benefit all users of the roads being shared with the rehabilitated driver.

The invention can be expected to find great acceptance with drivers, firstly because its implementation does not require the licensing authority to be informed of violations of traffic rules detected by the system and secondly because the invention can be implemented on a purely voluntary basis (i.e., no one is forced to have the system according to the invention installed or to use it), and thirdly because a driver can deactivate the system at any time if, nevertheless, he should feel patronized at any time.

The invention can be implemented as software which uses conventional hardware in modern motor vehicles, resulting in low cost. The system can and should be fully transparent for the user and also arbitrarily disconnectable so that the user never has the feeling of being bossed around in any way.

The driver is normally someone who is burdened with points (or loss of points) for driving contrary to rules in a traffic offenders file kept by the authorities. The operator of the data processing device belonging to the licensing authority is authorized to effect an improvement in the score of the driver in the traffic offenders file as soon as the data processing device is informed that the rating number has reached or exceeded the predetermined threshold value or that the rating number has remained at the predetermined threshold value or exceeded it for a predetermined driving time and/or predetermined driving distance (i.e., the predetermined threshold value is the rating number to be reached or exceeded or maintained by the driver so that he is credited with a point adjustment).

However, the invention is also suitable for other motor vehicle applications. It could be used for helping qualify new drivers, who initially are allowed to participate in road traffic only under certain restrictions. The monitoring of the present invention could enable them to gain a full-fledged driving license more quickly.

### BRIEF DESCRIPTION OF THE DRAWINGS

FIG. 1 shows a block diagram of a vehicle-based system for monitoring and analyzing the driving behavior of a driver who is burdened with points in a traffic offenders file.

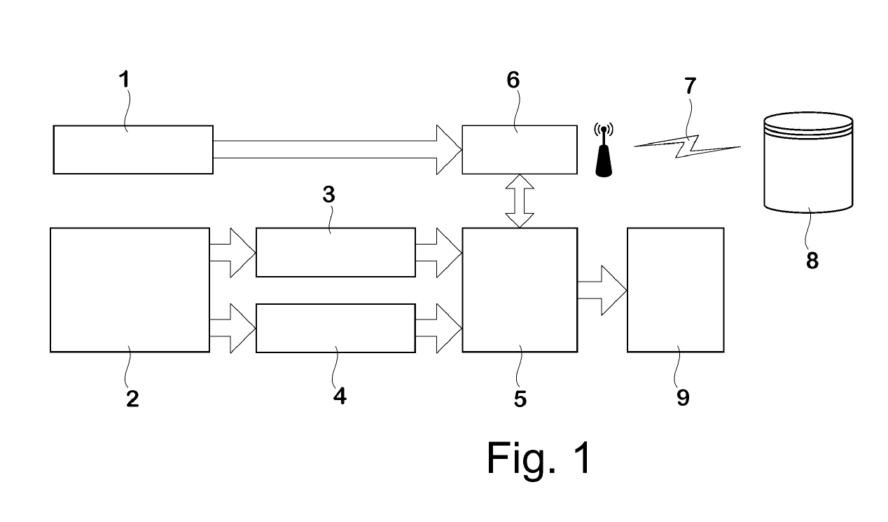

### DETAILED DESCRIPTION OF PREFERRED EMBODIMENTS

The system according to one embodiment of the present invention comprises a driver authentication module 1 and a plurality of sensors 2 in the motor vehicle. A traffic-rule-conformance evaluation module 3 is provided for evaluating the driving behavior of the driver with regard to the maintenance of elementary (i.e., legally enforceable) traffic rules, using data from at least one sensor 2. A defensive-driving-style evaluation module 4 is provided for evaluating the driving style of the driver under general safety aspects which are not or not always unambiguously specified by legal regulations using data from at least one sensor 2. A rating-number specification module 5 is provided for specifying a rating number and for continuously updating it by means of the current driving behavior and driving style of the driver determined in the evaluation modules 3 and 4. A communication module 6 is coupled to rating module 5 and authentication module 1. All of the aforementioned modules are located in the motor vehicle.

The communication module 6 receives data from the driver authentication module 1 and can exchange data with the rating-number specification module 5. The communication module 6 can also establish a bidirectional data link by mobile radio 7 (GSM, GPRS, UMTS, CDMA, etc.) with a data processing device 8 which also belongs to the system but which is located at a remote place and which is controlled by a licensing authority or its service provider collaborating with it and which authority or service provider is authorized to effect an improvement in the score of the driver in the traffic offenders file.

The driver authentication module 1 enables the identity of the driver to be identified or confirmed so that any points to be credited are credited to the actual driver of the motor vehicle and not to anyone else. Methods for such a driver identification are well known in the prior art. The driver authentication module 1 also enables one and the same person to be able to cumulatively use the system in different motor vehicles which are set up for using the system.

Sensors 2 comprise many sensors which are either standard or common accessories in modern motor vehicles such as, e.g., a speedometer, sensors for detecting steering-wheel and accelerator-pedal positions, a radar sensor which can be used for measuring the distance from a preceding vehicle, a camera which can be used for automatic traffic signal detection, a satellite navigation device which can be used for determining local speed restrictions from location data and digital maps, or the like.

The traffic-rule-conformance evaluation module 3 evaluates the driving behavior of the driver with regard to adherence to elementary traffic rules which are specified unambiguously by legal regulations and can be checked for adherence by means of the sensor signals, using the sensor data. For example, the evaluation module 3 determines whether the driver has applied his safety belt, whether he adheres to local and general speed restrictions, whether he observes traffic lights, whether he stops at stop signs etc. The evaluation module 3 supplies the individual results and/or mean values of the frequencies of compliance with these rules, which represent an evaluation standard for the corresponding driving behavior, to the rating-number specification module 5.

The defensive-driving-style evaluation module 4 evaluates the driving style of the driver under general safety aspects which are not or not always unambiguously specified by legal regulations, using the sensor data. For example, the evaluation module 4 determines mean values of the frequencies of severe steering-wheel and accelerator-pedal movements, of abrupt speed changes, of following distances from preceding vehicles presenting safety problems even if these are possibly not prohibited in the actual traffic situation or by specific regulations. A nonexistence of rare occurrence of such situations or events is interpreted as an indication of a non-aggressive, defensive, safe driving style. The evaluation module 4 supplies the mean values, which represent an evaluation standard for the corresponding driving style, to the rating-number specification module 5.

Other criteria which can be evaluated by the defensive-driving-style evaluation module 4 can be, e.g., whether the driver has necessary maintenance work performed on the motor vehicle, whether the vehicle emission values are in order, whether the tire pressures are correct, provided that corresponding data are available which allow the current general technical state of the motor vehicle to be inferred.

The overall system, and thus the rating-number specification module 5 will only operate when it is switched on by the driver. The specification module 5 specifies a rating number on the basis of the evaluation results of the evaluation modules 3 and 4, which can initially be zero after the switching-on, and updates these continuously. This can be done in a similar manner as in the case of known energy-saving techniques offered on commercially available vehicles designated as the “ECO mode,” especially with regard to parameters monitored with respect to the driving style evaluated by the defensive-driving-style evaluation module 4. In the ECO mode, sensor signals are used to analyze how the motor vehicle is operated, and the results are reported to the driver, but with the purpose of providing tips for saving fuel.

The rating number can be specified and updated in dependence on the history of the types of infractions in the traffic offenders file. For example, it is possible to ensure that drivers who have become penalized rarely or only with fewer serious traffic offences can obtain higher rating numbers and possibly larger credits in their points rating more rapidly than drivers who have become penalized frequently or with serious traffic offenses. The latter must then display a better driving behavior for a longer time or driving distance in order to be rewarded for this.

Depending on the initial values of the evaluation modules 3 and 4 and a weighting given to each event or each mean value, respectively, the rating-number specification module 5 increments or decrements the rating number. The rating number becomes gradually larger when the driver always drives according to rules and defensively, but becomes smaller again if not.

The weightings which are given to the events or mean values supplied by the evaluation modules 3 and 4 can be adapted in correspondence with the type and number of available sensor data. For example, the speed profile can be weighted more if no traffic signal detection is possible.

The weightings can also be tailored to a traffic infraction profile of the driver if available. For example, the entire part or a predominant part of the weighting can be placed on whether the driver adheres to the speed limits in the case of a driver which has become penalized particularly frequently for driving too fast.

As soon as the driver is allocated a rating number which exceeds a predetermined threshold value for a predetermined driving time and/or a predetermined driving distance, this fact is reported to the data processing device 8 via the communication module 6 over a wireless connection 7, which can be done either automatically or at the request of the driver. The driver is hereupon credited with a predetermined adjustment (e.g., one point) in his score in the traffic offenders file, the rating number is reset to its initial value, and the system begins to operate again from the start.

The score in the traffic offenders file stored by the licensing authority cannot be degraded by the system and the responsible authority is not informed, either, whether the driver uses the system or not or how large the rating number is if it is smaller than the threshold value. Apart from the necessary driver identification data, the authority only receives the information that the rating number has reached or exceeded—or preferably reached or exceeded for a certain driving time or driving distance—the threshold value.

Nevertheless, there can be a return link from the data processing device 8 via the communication module 6 and wireless radio link 7 to the rating-number specification module 5 in order to enable the rating-number specification module 5 to perform the evaluation by taking into consideration the current score of the driver in the traffic offenders file, the history of the score, of the traffic violation profile of the driver or the like.

It can be provided that the rating number is reset or reduced automatically to its initial value if the driver switches off the system. But the rating number should not be reset automatically when the motor vehicle is only parked.

The system also comprises a driver/vehicle interface 9, for example a video screen or voice output device which supplies the driver with information, especially the following: his current rating number which is incremented or decremented dynamically during his driving; the distance from the rating number which the driver must reach in order to be credited with a point; possibly individual events or mean values as determined by the evaluation modules 3 and 4, e.g., mean driving distance without exceeding speed restrictions or driving time without any transgression of laws which can be indicated by means of responding graphic symbols similar to the ECO mode; the remaining score in the traffic offenders files; and so on.

What is claimed is:

1. A system for monitoring and analyzing the driving behavior of a driver in a motor vehicle, comprising:
a driver authentication module for identifying the driver;
a rule evaluation module evaluating adherence to predetermined traffic rules in response to data from sensors in the motor vehicle;
a style evaluation module evaluating the driving style of the driver according to general safety aspects not specified by legal regulations in response to data from sensors in the motor vehicle;
a rating module continuously updating a rating number to represent a measure of conformance to the predetermined traffic rules from the rule evaluation module and a measure of the driving style from the style evaluation module; and
a communication module coupled to the rating module and establishing a data link with a remote data processing device for a licensing authority;
wherein, after the rating number has reached or exceeded a predetermined threshold value, the fact of reaching or exceeding the threshold value is reported to the remote data processing device via the communication module.

2. The system of claim 1 wherein the driver has been penalized according to points stored in a traffic offenders file kept by the licensing authority, and wherein the licensing authority is authorized to effect an improvement in the points stored in the traffic offenders file as soon as the data processing device is informed that the rating number has reached or exceeded the predetermined threshold value or that the rating number has remained at the predetermined threshold value or exceeded it for a predetermined driving time or predetermined driving distance.

3. The system of claim 1 wherein the system can be switched on and off arbitrarily by the driver.

4. The system of claim 1 wherein the sensors include at least one of a speedometer, a steering-wheel position sensor, an accelerator-pedal position sensor, a radar sensor, a camera, and a satellite navigation device.

5. The system of claim 1 wherein the rule evaluation module evaluates the driving behavior of the driver with regard to whether the driver has applied his safety belt, whether the driver adheres to speed restrictions, whether the driver obeys traffic lights, and whether the driver obeys stop signs.

6. The system of claim 1 wherein the style evaluation module evaluates the driving style of the driver with regard to severity of steering-wheel and accelerator-pedal movements, abrupt speed changes, and following distances from preceding vehicles.

7. The system of claim 1 wherein the rating module specifies the rating number on the basis of predetermined events which it receives from the rule evaluation module and the style evaluation module, and wherein respective events are weighted differently than other events.

8. The system of claim 1 further comprising a driver/vehicle interface which indicates information to the driver including a current rating number and a difference between the current rating number and the predetermined threshold value.
